(19) United States
(12) Patent Application Publication
(10) Pub. No.: US 2008/0089623 A1
(43) Pub. Date: Apr. 17, 2008

(54) Synch-Motion Spacer for a Guide Device

(76) Inventors: Yun-Yi LIN, Taichung (TW); Hsin-Tsun Hsu, Taichung (TW)

Correspondence Address: Dr. BANGER SHIA, 102 Lindencrest Ct., Sugar Land, TX, 77479-5201, US

(21) Appl. No.: 11/548,378

(22) Filed: Oct. 11, 2006

(51) Int. Cl. F16C 19/00

(52) U.S. Cl. 384/51

(57) ABSTRACT

A Synch-Motion spacer comprises a plurality of spacer elements, and strip-shaped links. An abutting surface is formed on each of the spacer elements and is located on the outer periphery of the receiving space and is arranged in the rolling direction of the rolling elements. An interval L being 0.3% larger than the abutting portion is formed in the abutting portion and is located in the rolling direction of the rolling elements. The abutting portion is made of thermoplastic polyamide elastomer with an elongation of 0-0.3%. The elongation of the spacer after oil immersion is less than the interval between the rolling elements and the spacers, so that no interference will be caused between the rolling elements.

### BACKGROUND OF THE INVENTION

1. Field of the Invention

The present invention relates to a spacer, and more particularly to a Synch-Motion spacer for a guide device that can prevent the occurrence of interference between the rolling elements and the spacer elements.

2. Description of the Prior Art

Linear guideway is used more and more widely in modern industries. In addition to its high precision transmission performance, the linear guideway also has many other advantages, such as low friction loss, high ratio of energy conversion, low noise, high rigidity and wear-resistance. Therefore, it is self-evident that the linear guideway is very important to various industrial mechanisms.

Normally, the linear guideway is provided with a plurality of spacers synchronously operating with the rolling elements for enabling the rolling elements between the rail and the sliding block to circulate endlessly. The synchronously operating spacers are the key to enable the rolling elements to circulate.

The problem of the conventional products commonly seen on the market is that: the spacers are usually made of plastic injection molding, and the spacers, the lubricants, and the rolling elements move synchronously within the linear guideway. The material and the structural design of the spacers are not good and will adversely affect the stability of the distance between the spacers and the rolling elements, and the spacers are likely to interfere with the rolling elements at the return portion of the linear guideway, thus affecting the operating stability of the linear guideway.

To solve the abovementioned problem, U.S. Pat. No. 5,988,883 disclosed another synchronously operating spacer for a guide device. This patent relates to “endless retainer of guide device and fabrication method thereof”. The spacer is made of thermoplastic polyamide-base elastomer and polyester-base elastomer, and is made by injection molding. However, this conventional spacer structure still has the following problems:

Firstly, poor wearability: the operation of a guide device is a reciprocating motion, therefore, a synchronously operating spacer of the guide device should have a good wearability so as to overcome the wear and tear caused by the reciprocating motion. However, the materials proposed in U.S. Pat. No. 5,988,883 don't have a qualified wearability.

Secondly, poor elasticity: the spacer of the guide device must be constantly subjected to a longitudinally pulling force during the reciprocating motion. If the material of the spacer is susceptible to permanent deformation under a stress, the guide device can't run smoothly and will be reduced in service life. Further, the spacer will not be liable to swerve when moving to the return portion since the elasticity of the spacer is poor. And as a result, the guide device can't move smoothly.

Thirdly, poor oil resistant: the spacer is formed with a plurality of receiving spaces for reception of the rolling elements, and then the spacer inserted with the rolling elements is moveably installed in the guide device. Since the space in the return portion of the guide device is fixed, the interval between spacer and the rolling elements must be kept at a constant value, otherwise, the rolling elements can't move smoothly. However, the spacer is liable to expand excessively when in contact with oil, as a result, the interval between spacer and the rolling elements will disappear, accordingly, the rolling elements can't move smoothly. Particularly, when moving through the return portion, the excessively expanded spacer is hard to move smoothly because the interval is too small.

The present invention has arisen to mitigate and/or obviate the afore-described disadvantages.

### SUMMARY OF THE INVENTION

The primary objective of the present invention is to provide a Synch-Motion spacer for a guide device that can prevent the occurrence of interference between the rolling elements and the spacer elements.

The Synch-Motion spacer in accordance with the present invention comprises a plurality of spacer elements, and strip-shaped links. An abutting surface is formed on each of the spacer elements and is located on the outer periphery of the receiving space and is arranged in the rolling direction of the rolling elements. An interval L being 0.3% larger than the abutting portion is formed in the abutting portion and is located in the rolling direction of the rolling elements. The abutting portion is made of thermoplastic polyamide elastomer with an elongation of 0-0.3%. The elongation of the spacer after oil immersion is less than the interval between the rolling elements and the spacers, so that no interference will be caused between the rolling elements.

The secondary objective of the present invention is to provide a Synch-Motion spacer for a guide device made of thermoplastic polyamide elastomer.

The abutting portion is made of thermoplastic polyamide elastomer with an elongation of 0-0.3%, so as to prevent the occurrence of permanent deformation of the spacer. And the thermoplastic polyamide elastomer improves the wearability.

### BRIEF DESCRIPTION OF THE DRAWINGS

FIG. 1 is an assembly view in accordance with the present invention of showing the spacer and the rolling elements;

FIG. 2 is another assembly view in accordance with the present invention of showing the spacer and the rolling elements;

FIG. 3 is an illustrative view in accordance with the present invention of showing that the expansion test of the spacer after oil immersion;

FIG. 4 is an illustrative view in accordance with the present invention of showing that the shrink test of the spacer after oil immersion;

FIG. 5 is an illustrative view in accordance with the present invention of showing the relation between the time of oil immersion and the elongation;

FIG. 6 is another illustrative view in accordance with the present invention of showing the relation between the time of oil immersion and the elongation;

FIG. 7 is another illustrative view in accordance with the present invention of showing the relation between the time of oil immersion and the elongation;

FIG. 8 is an illustrative view in accordance with the present invention of showing the relation between the elongation and the increased resistance force; and

FIG. 9 is an illustrative view in accordance with the present invention of showing the abutting portion.

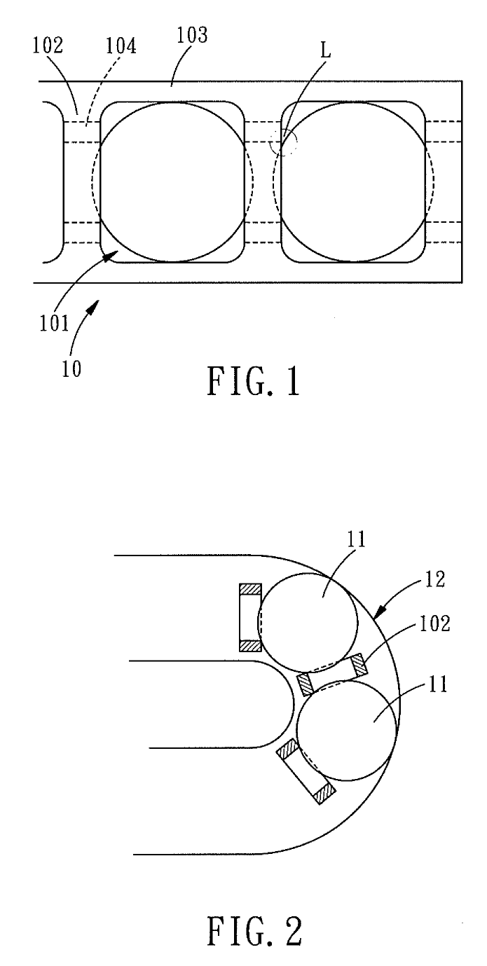

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

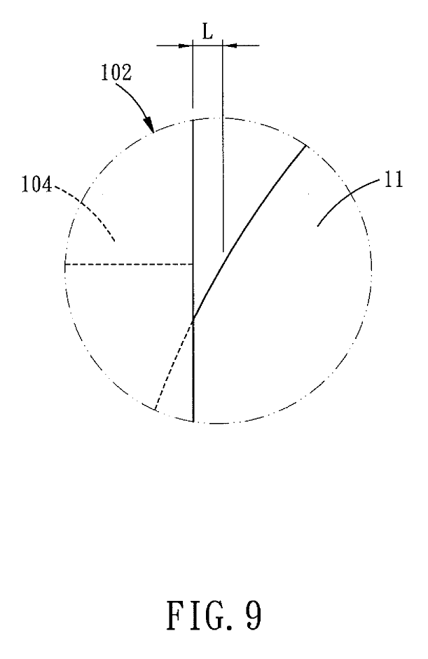

Referring to FIG. 9, a spacer 10 in accordance with the present invention comprises a plurality of spacer elements 102 and two strip-shaped links 103 for connecting the spacer elements 102 together. Each of the spacer elements 102 is formed with a receiving space 101 and is disposed between the rolling elements 11. An abutting surface 104 is formed on each of the spacer elements 102 and is located on the outer periphery of the receiving space 101 and is arranged in the rolling direction of the rolling elements. An interval L being 0.3% larger than the abutting portion 104 is formed in the abutting portion 104 and is located in the rolling direction of the rolling elements. The abutting portion 104 is made of thermoplastic polyamide elastomer with an elongation of 0-0.3%.

Regarding the experiment of this embodiment, reference should be made to the following descriptions. The experiment shows that the optimum ambient temperature is 24° C., and humidity is optimally 55%. The acceptable ambient temperature and humidity (at which the elongation after absorbing oil is to be calculated) are 20-30° C., and 50-60%. The oil absorption in the test reaches saturation.

What follows are the oil used in the tests:
(1) the ingredient of the soybean oil is soybean oil, viscosity: ISO-VG10-5.428 CST(40° C.);
(2) hydrocarbon oil contains poly-alpha-olefin oil, viscosity: ISO-VG680-680 CST (40° C.);
(3) refined mineral oil contains paraffinic-base-oil, viscosity: ISO-VG68-68 CST (40° C.);

Various flexible materials are used in the oil-immersion test and are tested for their oil-proof properties, and the final products after oil-immersion test are installed in the guide device for testing the resistance value, and what follows are the test results:

1. results of the oil-immersion test:

| | | | | |
|---|---|---|---|---|
| | elongation % | elongation % | elongation % | elongation % |
| | (immersed for | (immersed for | (immersed for | (immersed for |
| material | 100 hours) | 200 hours) | 300 hours) | 400 hours) |

1. oil tested - soybean oil

| | | | | |
|---|---|---|---|---|
| ◯ thermoplastic | 1.78 | 1.88 | 1.92 | 1.95 |
| polyester-base elastomer | | | | |
| □ thermoplastic | 0.07 | 0.12 | 0.12 | 0.12 |
| polyurethane-base | | | | |
| elastomer | | | | |
| Δ vulcanized | 1.75 | 1.75 | 1.75 | 1.75 |
| thermoplastic rubber | | | | |

2. oil tested - hydrocarbon oil

| | | | | |
|---|---|---|---|---|
| ◯ thermoplastic | 0.70 | 1.02 | 1.04 | 1.06 |
| polyester-base elastomer | | | | |
| □ thermoplastic | 0.20 | 0.24 | 0.29 | 0.29 |
| polyurethane-base | | | | |
| elastomer | | | | |
| Δ vulcanized | −0.93 | −1.44 | −1.5 | −1.53 |
| thermoplastic rubber | | | | |

3. oil tested - refined mineral oil

| | | | | |
|---|---|---|---|---|
| ◯ thermoplastic | 0.19 | 0.47 | 0.57 | 0.66 |
| polyester-base elastomer | | | | |
| □ thermoplastic | 0.04 | 0.04 | 0.04 | 0.04 |
| polyurethane-base | | | | |
| elastomer | | | | |
| Δ vulcanized | 6.23 | 6.76 | 6.76 | 6.76 |
| thermoplastic rubber | | | | |

1. results of the oil-immersion test:

| | oil tested | | | | | |
|---|---|---|---|---|---|---|
| | | | | | refined mineral | |
| | soybean oil | | hydrocarbon oil | | oil | |
| | | value of | | value of | | value of |
| | | increased | | increased | | increased |
| | | resistance | | resistance | | resistance |
| material | elongation % | (kg) | elongation % | (kg) | elongation % | (kg) |

value of increased resistance (kg) after 100 hours

| | | | | | | |
|---|---|---|---|---|---|---|
| ∘ thermoplastic | 1.78 | 0.09 | 0.70 | 0.04 | 0.19 | 0.01 |
| polyester-base elastomer | | | | | | |
| □ thermoplastic | 0.07 | 0.003 | 0.20 | 0.005 | 0.04 | 0.002 |
| polyurethane-base | | | | | | |
| elastomer | | | | | | |
| Δ vulcanized | 1.75 | 0.08 | −0.93 | | 6.23 | 0.30 |
| thermoplastic rubber | | | | | | |

value of increased resistance (kg) after 200 hours

| | | | | | | |
|---|---|---|---|---|---|---|
| ∘ thermoplastic | 1.88 | 0.11 | 1.02 | 0.05 | 0.47 | 0.025 |
| polyester-base elastomer | | | | | | |
| □ thermoplastic | 0.12 | 0.004 | 0.24 | 0.006 | 0.04 | 0.003 |
| polyurethane-base | | | | | | |
| elastomer | | | | | | |
| Δ vulcanized | 1.75 | 0.09 | −1.44 | | 6.76 | 0.38 |
| thermoplastic rubber | | | | | | |

value of increased resistance (kg) after 300 hours

| | | | | | | |
|---|---|---|---|---|---|---|
| ∘ thermoplastic | 1.92 | 0.1 | 1.04 | 0.05 | 0.57 | 0.03 |
| polyester-base elastomer | | | | | | |
| □ thermoplastic | 0.12 | 0.003 | 0.29 | 0.009 | 0.04 | 0.002 |
| polyurethane-base | | | | | | |
| elastomer | | | | | | |
| Δ vulcanized | 1.75 | 0.08 | −1.5 | | 6.76 | 0.35 |
| thermoplastic rubber | | | | | | |

value of increased resistance (kg) after 400 hours

| | | | | | | |
|---|---|---|---|---|---|---|
| ∘ thermoplastic | 1.95 | 0.11 | 1.06 | 0.06 | 0.66 | 0.035 |
| polyester-base elastomer | | | | | | |
| □ thermoplastic | 0.12 | 0.003 | 0.29 | 0.008 | 0.04 | 0.002 |
| polyurethane-base | | | | | | |
| elastomer | | | | | | |
| Δ vulcanized | 1.75 | 0.09 | −1.53 | | 6.76 | 0.36 |
| thermoplastic rubber | | | | | | |

To obtain an anticorrosive effect or for the purpose of lubrication, the surface of the guiding device is usually coated with oil or the whole guiding device is dipped into oil. The Synch-Motion spacer 10 made of thermoplastic Polyester-base elastomer or vulcanized thermoplastic rubber will not be stable when in contact with oil, and will affect the interval between spacer and the rolling elements. Therefore, the test results show the following problems:

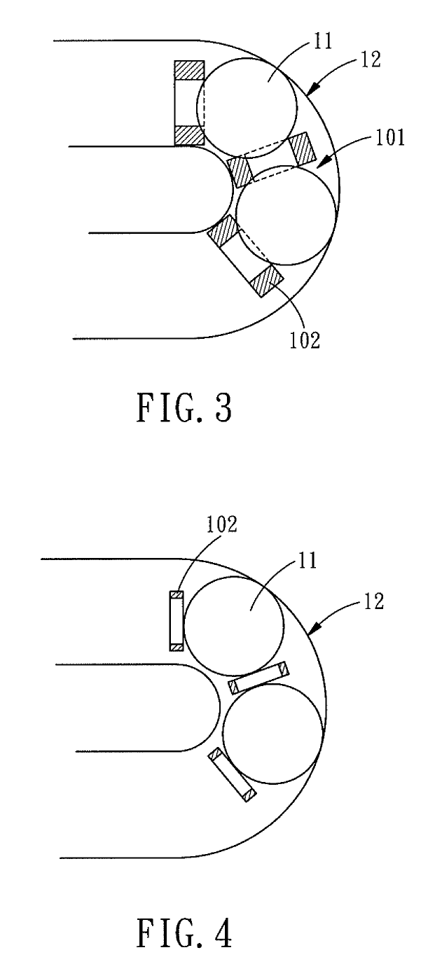

1. Synch-Motion spacer 10 will expand when in contact with oil: the spacer 10 is formed with a plurality of receiving spaces 101 for reception of a plurality of rolling elements 11, the interval L is formed between the rolling elements 11 and the receiving spaces 101. If the Synch-Motion spacer 10 expands when in contact with oil, the receiving spaces 101 will be reduced, as a result, the Synch-Motion spacer 10 will hold the rolling elements 11 too tightly, or will interfere with the rolling elements 11. Accordingly, the resistance force of the rolling elements 11 will be too large. Further, the Synch-Motion spacer 10 will swell and fill up the return portion 12 when moving within the return portion 12, as a result, the guide device can't move smoothly (as shown in FIG. 3).

2. Synch-Motion spacer 10 will contract when in contact with oil: the spacer 10 is formed with a plurality of receiving spaces 101 for reception of a plurality of rolling elements 11, the interval L is formed between the rolling elements 11 and the receiving spaces 101. If the Synch-Motion spacer 10 contracts when in contact with oil, the receiving spaces 101 will be enlarged, as a result, the Synch-Motion spacer 10 can't hold the rolling elements 11 tightly. Accordingly, the rolling elements 11 are likely to impact the returning portion 12, causing noise, or even worse, the rolling elements 11 are liable to fall off (as shown in FIG. 4).

The abutting surface 104 is formed on each of the spacer elements 102 and is located on the outer periphery of the receiving space 101 and is arranged in the rolling direction of the rolling elements. The abutting portion 104 is made of thermoplastic polyamide elastomer with an elongation of 0-0.3%. The aforementioned oil-immersion tests show that the elongation of the thermoplastic polyamide elastomer can be controlled between 0% and 0.3%.

What follows are the test results of each of the thermoplastic polyurethane elastomer, the thermoplastic polyester-base elastomer, the vulcanized thermoplastic rubber immerged in soybean oil, hydrocarbon oil, and mineral oil.

1: immerged in soybean oil:

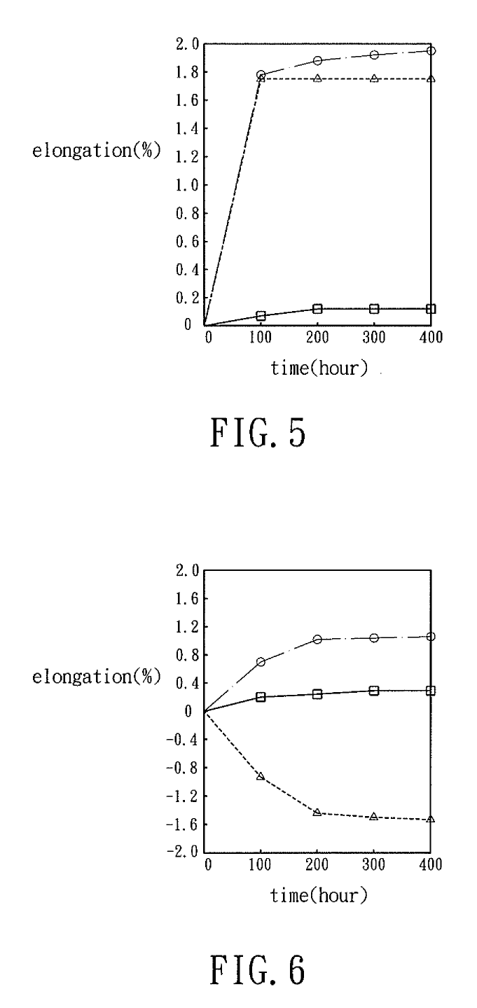

the elongation of the thermoplastic polyurethane elastomer and the vulcanized thermoplastic rubber after 100 hours oil immersion are over 1.75%. The elongation of the thermoplastic polyester-base elastomer is as great as 0.07% after 100 hours oil immersion, and will be 0.12% after 200 hours oil immersion (as shown FIG. 5).

2. immerged in hydrocarbon oil:

the elongation of the thermoplastic polyurethane elastomer is 0.70% after 100 hours oil immersion and is over 1.02% after 200 hours oil immersion. The elongation of the vulcanized thermoplastic rubber is =0.93% after 100 hours oil immersion and is over −1.44% after 200 hours oil immersion. The elongation of the thermoplastic polyester-base elastomer is as great as 0.20% after 100 hours oil immersion, and will be 0.24 after 200 hours oil immersion (as shown FIG. 6).

3. immerged in refined mineral oil:

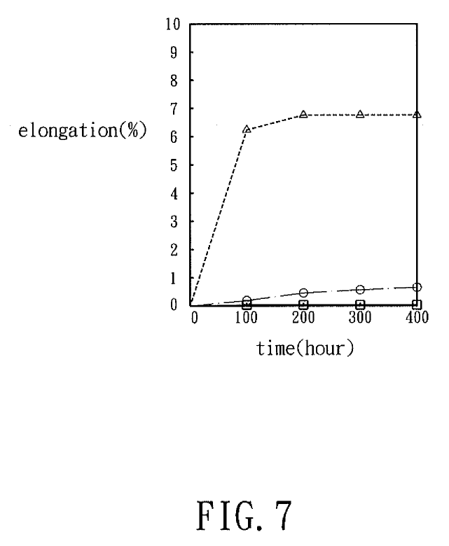

the elongation of the thermoplastic polyurethane elastomer is 0.19% after 100 hours oil immersion and is over 0.47% after 200 hours oil immersion. The elongation of the vulcanized thermoplastic rubber is 6.23% after 100 hours oil immersion. The elongation of the thermoplastic polyester-base elastomer is 0.04% after 100, 200, 300, and 400 hours oil immersion (as shown FIG. 7).

The test results show that the elongation of the thermoplastic polyurethane elastomer dipped is very high no matter it is dipped in immerged in soybean oil, hydrocarbon oil, or mineral oil, and the thermoplastic polyurethane elastomer will expand excessively. Sometimes, the vulcanized thermoplastic rubber will expand excessively, and sometimes will contract. These two materials are very unstable. Only the thermoplastic polyester-base elastomer is very stable no matter it is dipped in immerged in soybean oil, hydrocarbon oil, or mineral oil.

The final products (thermoplastic polyurethane elastomer, the thermoplastic polyester-base elastomer, the vulcanized thermoplastic rubber) after oil-immersion test are installed in the guide device for testing the increased resistance value, and what follows are the test results:

The increased resistance value of the thermoplastic polyurethane elastomer is 0.01-0.11 kg, the increased resistance value of the thermoplastic polyester-base elastomer is 0.002-0.009 kg, and the increased resistance value of the vulcanized thermoplastic rubber is 0.08-0.38 kg.

The increased resistance values of the respective materials after the elongation is stabilized are as follows: the increased resistance value of the thermoplastic polyurethane elastomer is 0.035-0.11 kg, the increased resistance value of the thermoplastic polyester-base elastomer is 0.002-0.008 kg, and the increased resistance value of the vulcanized thermoplastic rubber is 0.09-0.36 kg. If the increased resistance force is too great, the guide device can't move smoothly, causing false press. And if the expanded sized is too great, the interval between the receiving space 101 and the rolling elements 11 will be reduced to 0.025-0.035 mm, and will causing interference with the rolling elements, affecting the operation of the guide device.

If the contracted sized is too great, the receiving space 101 will be enlarged, as a result, the Synch-Motion spacer 10 can't hold the rolling elements 11 tightly. Accordingly, the rolling elements 11 are likely to impact the returning portion 12, causing noise, or even worse, the rolling elements 11 are liable to fall off.

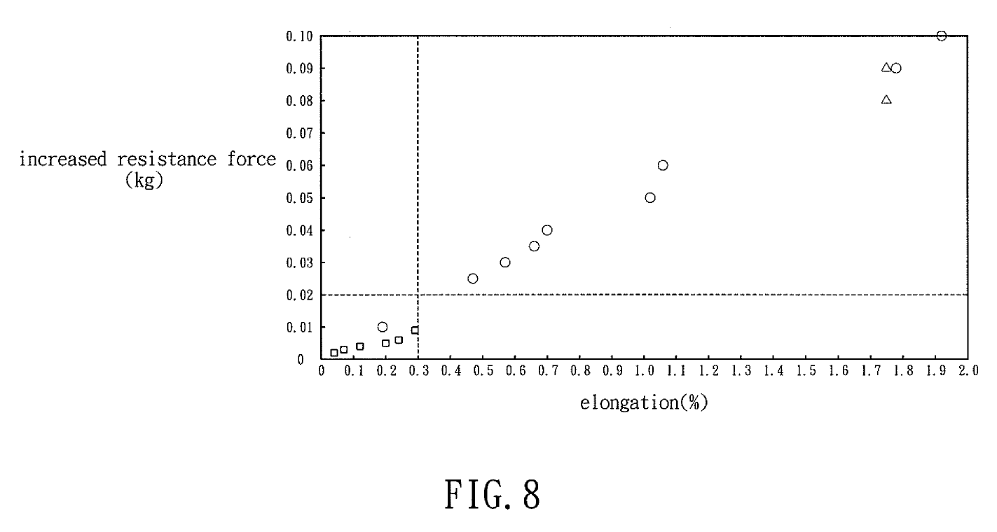

The test results show that when the elongation is less than 0.3%, the resultant increased resistant force will not change dramatically and can be controlled within 0.01 kg, and thus the guide device can move smoothly. If the elongation is larger than 0.3%, the resultant increased resistant force will change dramatically and will have a great influence on the operation of the guide device. And the test results show that only the thermoplastic polyester-base elastomer is very stable, when its elongation reaches the saturation point, the increased resistance force is so small that it can be neglected, so that the guide device can move smoothly (as shown in FIG. 8).

To summarize, the Synch-Motion spacer in accordance with the present invention comprises a plurality of spacer elements, and strip-shaped links. An abutting surface is formed on each of the spacer elements and is located on the outer periphery of the receiving space and is arranged in the rolling direction of the rolling elements. An interval L being 0.3% larger than the abutting portion is formed in the abutting portion and is located in the rolling direction of the rolling elements. The abutting portion is made of thermoplastic polyamide elastomer with an elongation of 0-0.3%. The elongation of the spacer after oil immersion is less than the interval between the rolling elements and the spacers, so that no interference will be caused between the rolling elements and the spacer when the guide device is coated with lubricant.

While we have shown and described various embodiments in accordance with the present invention, it is clear to those skilled in the art that further embodiments may be made without departing from the scope of the present invention.

What is claimed is:

1. A Synch-Motion spacer for a guide device comprising a plurality of spacer elements and strip-shaped links for connecting the spacer elements together, the spacer elements being located between a plurality of rolling elements, characterized in that:
an abutting surface is formed on each of the spacer elements and is located in rolling direction of the rolling elements, an interval being 0.3% larger than the abutting portion is formed in the abutting portion and is located in rolling direction of the rolling elements, the abutting portion is made of an elastic material with an elongation of 0-0.3%.

2. The Synch-Motion spacer for a guide device as claimed in claim 1, wherein the abutting portion is made of thermoplastic polyurethane-base elastomer.

3. The Synch-Motion spacer for a guide device as claimed in claim 1, wherein the elongation is calculated under the condition that the elastic material is saturated with soybean oil, hydrocarbon oil, or mineral oil.

4. The Synch-Motion spacer for a guide device as claimed in claim 3, wherein the soybean oil is a soybean oil with a viscosity: ISO-VG10-5.428 CST at 40° C.

5. The Synch-Motion spacer for a guide device as claimed in claim 3, wherein the hydrocarbon oil contains poly-alpha-olefin oil with a viscosity: ISO-VG680-680 CST at 40° C.

6. The Synch-Motion spacer for a guide device as claimed in claim 3, wherein the refined mineral oil contains paraffinic-base-oil with a viscosity: ISO-VG68-68 CST at 40° C.

7. The Synch-Motion spacer for a guide device as claimed in claim 4, wherein the acceptable ambient temperature and humidity at which the elongation after absorbing oil is to be calculated are 20-30° C., and 50-60%.

8. The Synch-Motion spacer for a guide device as claimed in claim 5, wherein the acceptable ambient temperature and humidity at which the elongation after absorbing oil is to be calculated are 20-30° C., and 50-60%.

9. The Synch-Motion spacer for a guide device as claimed in claim 6, wherein the acceptable ambient temperature and humidity at which the elongation after absorbing oil is to be calculated are 20-30° C., and 50-60%.
